(19) United States
(12) Patent Application Publication
(10) Pub. No.: US 2024/0243347 A1
(43) Pub. Date: Jul. 18, 2024

(54) BATTERY

(71) Applicant: Panasonic Intellectual Property Management Co., Ltd., Osaka (JP)

(72) Inventor: Takahiro KURABUCHI, Osaka (JP)

(21) Appl. No.: 18/473,940

(22) Filed: Sep. 25, 2023

Related U.S. Application Data
(63) Continuation of application No. PCT/JP2022/002072, filed on Jan. 20, 2022.

(30) Foreign Application Priority Data
Mar. 31, 2021 (JP) 2021-061756

(51) Int. Cl. H01M 10/0562

(52) U.S. Cl. CPC H01M 10/0562; H01M 2300/0071; H01M 2300/008; H01M 2300/0094

(57) ABSTRACT

A battery of the present disclosure includes a positive electrode, a first electrolyte layer, a second electrolyte layer, and a negative electrode in this order. The first electrolyte layer includes a first solid electrolyte. The second electrolyte layer includes a second solid electrolyte. The first solid electrolyte is different in composition from the second solid electrolyte. An average thickness of the first electrolyte layer is larger than an arithmetic average roughness of a surface of the second electrolyte layer. The surface is close to the first electrolyte layer. An average thickness of the second electrolyte layer is larger than an arithmetic average roughness of a surface of the first electrolyte layer. The surface is close to the second electrolyte layer.

This application is a continuation of PCT/JP2022/002072 filed on Jan. 20, 2022, which claims foreign priority of Japanese Patent Application No. 2021-061756 filed on Mar. 31, 2021, the entire contents of both of which are incorporated herein by reference.

### BACKGROUND OF THE INVENTION

### 1. Field of the Invention

The present disclosure relates to a battery.

### 2. Description of Related Art

JP 5692184 B discloses an all-solid-state battery including a positive electrode layer and a negative electrode layer that are laminated with a solid electrolyte layer sandwiched therebetween.

### SUMMARY OF THE INVENTION

In conventional techniques, further enhancement in output characteristics of the battery is desired.

A battery according to one aspect of the present disclosure includes a positive electrode, a first electrolyte layer, a second electrolyte layer, and a negative electrode in this order, wherein
the first electrolyte layer includes a first solid electrolyte,
the second electrolyte layer includes a second solid electrolyte,
the first solid electrolyte is different in composition from the second solid electrolyte,
an average thickness of the first electrolyte layer is larger than an arithmetic average roughness of a surface of the second electrolyte layer, the surface being close to the first electrolyte layer, and
an average thickness of the second electrolyte layer is larger than an arithmetic average roughness of a surface of the first electrolyte layer, the surface being close to the second electrolyte layer.

According to the present disclosure, it is possible to provide a battery having enhanced output characteristics.

### BRIEF DESCRIPTION OF THE DRAWINGS

FIG. 1 is a sectional view schematically showing the configuration of a battery according to Embodiment 1.

FIG. 2 is a diagram illustrating a method for manufacturing the battery according to Embodiment 1.

FIG. 3 is a sectional view schematically showing the configuration of a battery according to Embodiment 2.

FIG. 4 shows an example of a section including a first electrolyte layer and a second electrolyte layer according to Embodiment 2.

FIG. 5 is a sectional view schematically showing the configuration of a battery according to Embodiment 3.

FIG. 6 shows an example of a section including a first electrolyte layer and a second electrolyte layer according to Embodiment 3.

### DETAILED DESCRIPTION

Embodiments of the present disclosure will be described below with reference to the drawings.

The following descriptions are each a generic or specific example. The following numerical values, composition, shape, thickness, electrical characteristics, structure of secondary batteries, electrode materials, and the like are only exemplary, and are not intended to limit the present disclosure. In addition, the constituent elements that are not recited in the independent claim representing the broadest concept are optional constituent elements.

(Findings on which the Present Disclosure is Based)

JP 5692184 B discloses an all-solid-state battery including a positive electrode layer and a negative electrode layer that are laminated with a solid electrolyte layer sandwiched therebetween. The solid electrolyte layer has a single layer structure in which one surface is in contact with the positive electrode layer while the other surface is in contact with the negative electrode layer. Solid electrolytes each have an inherent potential window. Accordingly, in a solid electrolyte layer having a single layer structure as in the all-solid-state battery disclosed in JP 5692184 B, the solid electrolyte constituting the solid electrolyte layer is desired to be chemically stable in the respective operating potential ranges of the positive electrode and the negative electrode.

A solid electrolyte layer may have a multi-layer structure including a plurality of solid electrolyte layers that are laminated on top of each other and joined to each other. In this case, a solid electrolyte that is chemically more stable in the operating potential range of the positive electrode can be disposed so as to be in contact with the positive electrode. Moreover, a solid electrolyte that is chemically more stable in the operating potential range of the negative electrode can be disposed so as to be in contact with the negative electrode. A solid electrolyte layer having a multi-layer structure has greatly broadened options for the materials of the positive electrode, the negative electrode, and the solid electrolyte layers. Consequently, it is possible to achieve a battery having higher output characteristics than conventional batteries have.

On the other hand, the present inventor has found a problem of a solid electrolyte layer having a multi-layer structure in which a solid electrolyte that is chemically stable in the operating potential range of one electrode can be in contact with the other electrode depending on the state of the joined surface of the adjacent solid electrolyte layers. A solid electrolyte that is chemically stable in the operating potential range of one electrode may not be chemically stable in the operating potential range of the other electrode. In this case, when the solid electrolyte, which is chemically stable in the operating potential range of the one electrode, is in contact with the other electrode, the solid electrolyte becomes chemically transformed thus to increase the resistance component. This deteriorates the output characteristics of the battery.

As a result of intensive studies for enhancing the output characteristics of the battery, the present inventor has found a solid electrolyte layer having a multi-layer structure in which a solid electrolyte that is chemically stable in the operating potential range of one electrode can be prevented from being in contact with the other electrode. By using such a solid electrolyte layer, it is possible to enhance the output characteristics of the battery.

### (Overview of One Aspect According to the Present Disclosure)

A battery according to a first aspect of the present disclosure includes a positive electrode, a first electrolyte layer, a second electrolyte layer, and a negative electrode in this order, wherein
the first electrolyte layer includes a first solid electrolyte,
the second electrolyte layer includes a second solid electrolyte,
the first solid electrolyte is different in composition from the second solid electrolyte,
an average thickness of the first electrolyte layer is larger than an arithmetic average roughness of a surface of the second electrolyte layer, the surface being close to the first electrolyte layer, and
an average thickness of the second electrolyte layer is larger than an arithmetic average roughness of a surface of the first electrolyte layer, the surface being close to the second electrolyte layer.

According to the first aspect, it is possible to enhance the output characteristics of the battery.

In a second aspect of the present disclosure, for example, in the battery according to the first aspect, the average thickness of the first electrolyte layer may be 500 μm or less, and the average thickness of the second electrolyte layer may be 500 μm or less.

According to the second aspect, the battery can operate at a higher output. That is, it is possible to enhance the output characteristics of the battery while limiting the average thickness of the first electrolyte layer and the average thickness of the second electrolyte layer.

In a third aspect of the present disclosure, for example, in the battery according to the first or second aspect, the first solid electrolyte may be a particulate solid electrolyte, and an average particle diameter of the first solid electrolyte may be smaller than the arithmetic average roughness of the surface of the second electrolyte layer, the surface being close to the first electrolyte layer.

According to the third aspect, the first electrolyte layer and the second electrolyte layer have reduced voids therebetween. Consequently, it is possible to further enhance the output characteristics of the battery.

In a fourth aspect of the present disclosure, for example, in the battery according to the third aspect, on a section of the battery parallel to a thickness direction of the battery, when a reference line that passes through a point defining a maximum height of a surface profile of the second electrolyte layer and that is perpendicular to the thickness direction is defined as a first reference line, a first specific particle group of the first solid electrolyte may be present between the first reference line and the second electrolyte layer on the section, and the average particle diameter of the first solid electrolyte may be an average particle diameter of the first specific particle group.

According to the fourth aspect, the first electrolyte layer and the second electrolyte layer have reduced voids therebetween. Consequently, it is possible to sufficiently enhance the output characteristics of the battery.

In a fifth aspect of the present disclosure, for example, in the battery according to any one of the first to fourth aspects, the second solid electrolyte may be a particulate solid electrolyte, and an average particle diameter of the second solid electrolyte may be smaller than the arithmetic average roughness of the surface of the first electrolyte layer, the surface being close to the second electrolyte layer.

According to the fifth aspect, the first electrolyte layer and the second electrolyte layer have reduced voids therebetween. Consequently, it is possible to further enhance the output characteristics of the battery.

In a sixth aspect of the present disclosure, for example, in the battery according to the fifth aspect, on a section of the battery parallel to a thickness direction of the battery, when a reference line that passes through a point defining a maximum depth of a surface profile of the first electrolyte layer and that is perpendicular to the thickness direction is defined as a second reference line, a second specific particle group of the second solid electrolyte may be present between the second reference line and the first electrolyte layer on the section, and the average particle diameter of the second solid electrolyte may be an average particle diameter of the second specific particle group.

According to the sixth aspect, the first electrolyte layer and the second electrolyte layer have reduced voids therebetween. Consequently, it is possible to sufficiently enhance the output characteristics of the battery.

In a seventh aspect of the present disclosure, for example, in the battery according to any one of the first to sixth aspects, at least one selected from the group consisting of the first solid electrolyte and the second solid electrolyte may be a solid oxide electrolyte.

According to the seventh aspect, it is possible to further enhance the output characteristics of the battery.

In an eighth aspect of the present disclosure, for example, in the battery according to any one of the first to sixth aspects, at least one selected from the group consisting of the first solid electrolyte and the second solid electrolyte may be a solid sulfide electrolyte.

According to the eighth aspect, it is possible to further enhance the output characteristics of the battery.

In a ninth aspect of the present disclosure, for example, in the battery according to any one of the first to sixth aspects, at least one selected from the group consisting of the first solid electrolyte and the second solid electrolyte may include Li, M, and X. The M may be at least one selected from the group consisting of metalloid elements and metal elements except Li. The X may be at least one selected from the group consisting of F, Cl, Br, and I.

In a tenth aspect of the present disclosure, for example, in the battery according to the ninth aspect, the at least one selected from the group consisting of the first solid electrolyte and the second solid electrolyte may be represented by the following composition formula (1)

Li_{α}M_{β}X_{γ} Formula (1)
where α, β, and γ are each a value greater than 0.

According to the ninth to tenth aspects, it is possible to further enhance the output characteristics of the battery.

### Embodiment 1

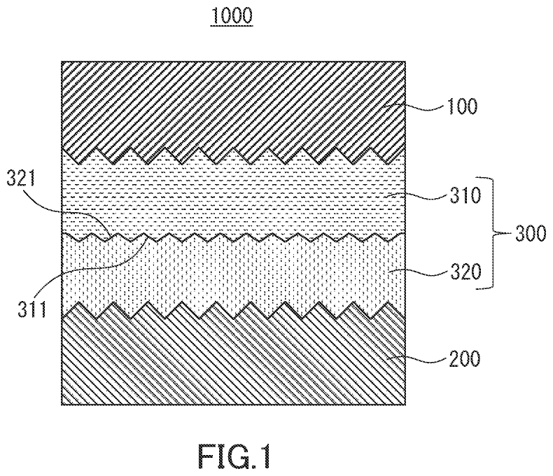

FIG. 1 is a sectional view schematically showing the configuration of a battery 1000 according to Embodiment 1.

The battery 1000 includes a positive electrode 100, a first electrolyte layer 310, a second electrolyte layer 320, and a negative electrode 200 in this order. The positive electrode 100, the first electrolyte layer 310, the second electrolyte layer 320, and the negative electrode 200 are laminated in this order. An electrolyte layer 300 includes the first electrolyte layer 310 and the second electrolyte layer 320. The electrolyte layer 300 is disposed between the positive electrode 100 and the negative electrode 200. The first electrolyte layer 310 includes a first solid electrolyte. The second electrolyte layer 320 includes a second solid electrolyte. The first solid electrolyte is a material different in composition from the second solid electrolyte. An average thickness D1 of the first electrolyte layer 310 is larger than an arithmetic average roughness Ra2 of a surface 321 of the second electrolyte layer 320. The surface 321 is close to the first electrolyte layer 310. An average thickness D2 of the second electrolyte layer 320 is larger than an arithmetic average roughness Ra1 of a surface 311 of the first electrolyte layer 310. The surface 311 is close to the second electrolyte layer 320.

According to the above configuration, it is possible to prevent the first solid electrolyte from being in contact with the second electrolyte layer and thus from becoming chemically transformed. Moreover, it is possible to prevent the second solid electrolyte from being in contact with the first electrolyte layer and thus from becoming chemically transformed. Consequently, it is possible to prevent an increase in resistance component inside the battery. Moreover, it is possible to select, as the first solid electrolyte, even a solid electrolyte that is chemically stable in the operating potential range of the positive electrode 100 but is not chemically stable in the operating potential range of the negative electrode 200, for example. It is possible to select, as the second solid electrolyte, even a solid electrolyte that is chemically stable in the operating potential range of the negative electrode 200 but is not chemically stable in the operating potential range of the positive electrode 100. Thus, the options for the first solid electrolyte and the second solid electrolyte are broadened. Therefore, it is possible to achieve the battery 1000 having enhanced output characteristics.

In the present embodiment, the electrolyte layer 300 is in contact with the positive electrode 100 and the negative electrode 200. Specifically, the first electrolyte layer 310 is in contact with the positive electrode 100. The second electrolyte layer 320 is in contact with the negative electrode 200. The first electrolyte layer 310 is in contact with the second electrolyte layer 320.

The average thickness D1 of the first electrolyte layer 310 may be two times or more or five times or more the arithmetic average roughness Ra2 of the surface 321, which is close to the first electrolyte layer 310, of the second electrolyte layer 320. The upper limit for the ratio D1/Ra2 of the average thickness D1 to the arithmetic average roughness Ra2 is not particularly limited. The ratio D1/Ra2 may be 100 or less or 1000 or less.

The average thickness D2 of the second electrolyte layer 320 may be two times or more or five times or more the arithmetic average roughness Ra1 of the surface 311, which is close to the second electrolyte layer 320, of the first electrolyte layer 310. The upper limit for the ratio D2/Ra1 of the average thickness D2 to the arithmetic average roughness Ra1 is not particularly limited. The ratio D2/Ra1 may be 100 or less or 1000 or less.

The average thickness D1 of the first electrolyte layer 310 and the average thickness D2 of the second electrolyte layer 320 can be measured by the following method. The sections of the first electrolyte layer 310 and the second electrolyte layer 320 are observed with a scanning electron microscope (SEM). The sections are each a section parallel to the lamination direction of the layers and including the center of gravity of the first electrolyte layer 310 or the second electrolyte layer 320 as viewed in plan. From the sectional SEM image obtained, 10 points are randomly selected. The thickness of the electrolyte layer is measured at the 10 points randomly selected. The average value of the measured values is determined as the average thickness.

In the present embodiment, the arithmetic average roughness refers to the arithmetic average roughness (Ra) specified in Japanese Industrial Standards JIS B 0601-2001. The arithmetic average roughness Ra1 of the surface 311 of the first electrolyte layer 310 and the arithmetic average roughness Ra2 of the surface 321 of the second electrolyte layer 320 can be measured by the following method. The sections of the first electrolyte layer 310 and the second electrolyte layer 320 are observed with a scanning electron microscope. The sections are each a section parallel to the lamination direction of the layers and including the center of gravity of the first electrolyte layer 310 or the second electrolyte layer 320 as viewed in plan. From the sectional SEM image obtained, the contour curve of the surface 311 or the surface 321 is extracted as the roughness curve. From the roughness curve, a portion stretching over a reference length L (e.g., 500 μm) in the direction of the average line is cut out. In the cut portion having the reference length L, the X-axis is defined in the direction of the average line, and the Y-axis is defined in the height direction of the cut portion. The value represented in micrometers (μm) determined by the following equation is regarded as the arithmetic average roughness, where the roughness curve is represented as y=f(x).

$$Ra = \frac{1}{L} {\int }_{0}^{L} \vert f ( x ) \vert dx$$

The average thickness D1 of the first electrolyte layer 310 and the average thickness D2 of the second electrolyte layer 320 each may be 1 μm or more and 1000 μm or less. In the case where the average thickness of each of the first electrolyte layer 310 and the second electrolyte layer 320 is 1 μm or more, the positive electrode 100 and the negative electrode 200 are less prone to short-circuit. In the case where the average thickness of each of the first electrolyte layer 310 and the second electrolyte layer 320 is 1000 μm or less, the battery 1000 can operate at a high output. The average thickness D1 of the first electrolyte layer 310 and the average thickness D2 of the second electrolyte layer 320 may be equal to or different from each other.

The average thickness D1 of the first electrolyte layer 310 and the average thickness D2 of the second electrolyte layer 320 each may be 6 μm or more and 500 μm or less. In the case where the average thickness of each of the first electrolyte layer 310 and the second electrolyte layer 320 is 6 μm or more, the positive electrode 100 and the negative electrode 200 are much less prone to short-circuit. In the case where the average thickness of each of the first electrolyte layer 310 and the second electrolyte layer 320 is 500 μm or less, the battery 1000 can operate at a higher output.

The arithmetic average roughness Ra1 of the surface 311 and the arithmetic average roughness Ra2 of the surface 321 each may be 0.1 μm or more and 10 μm or less. In the case where the arithmetic average roughness of each of the surface 311 and the surface 321 is 0.1 μm or more, a sufficient contact is achieved between the first electrolyte layer 310 and the second electrolyte layer 320. In the case where the arithmetic average roughness of each of the surface 311 and the surface 321 is 10 μm or less, the first electrolyte layer 310 and the second electrolyte layer 320 have sufficiently reduced voids therebetween. Consequently, the battery 1000 can operate at a high output. The arithmetic average roughness Ra1 of the surface 311 and the arithmetic average roughness Ra2 of the surface 321 may be equal to or different from each other.

The arithmetic average roughness Ra1 of the surface 311 and the arithmetic average roughness Ra2 of the surface 321 each may be 1 μm or more and 5 μm or less. In the case where the arithmetic average roughness of each of the surface 311 and the surface 321 is 1 μm or more, a more sufficient contact is achieved between the first electrolyte layer 310 and the second electrolyte layer 320. In the case where the arithmetic average roughness of each of the surface 311 and the surface 321 is 5 μm or less, the first electrolyte layer 310 and the second electrolyte layer 320 have further reduced voids therebetween. Consequently, the battery 1000 can operate at a higher output.

The electrolyte layer 300 has a multi-layer structure. Accordingly, the electrolyte layer 300 that can be used is, an electrolyte layer including a solid electrolyte with a low oxidation resistance and an electrolyte layer including a solid electrolyte with a low reduction resistance. The first electrolyte layer 310 that can be used is, for example, a solid electrolyte layer including a solid electrolyte with a low reduction resistance. The second electrolyte layer 320 that can be used is, for example, a solid electrolyte layer including a solid electrolyte with a low oxidation resistance. According to the above configuration, the electrolyte layer has reduced internal resistance. Consequently, it is possible to enhance the output characteristics of the battery 1000.

The first electrolyte layer 310 may include the first solid electrolyte in a mass proportion of 100 mass % relative to the total mass of the first electrolyte layer 310, except for inevitably incorporated impurities. That is, the first electrolyte layer 310 may be formed of substantially only the first solid electrolyte. The second electrolyte layer 320 may include the second solid electrolyte in a mass proportion of 100 mass % relative to the total mass of the second electrolyte layer 320, except for inevitably incorporated impurities. That is, the second electrolyte layer 320 may be formed of substantially only the second solid electrolyte.

The first electrolyte layer 310 may include the first solid electrolyte as its main component and further include inevitable impurities, or a starting material for use in synthesizing the first solid electrolyte, a by-product, and a decomposition product. The second electrolyte layer 320 may include the second solid electrolyte as its main component and further include inevitable impurities, or a starting material for use in synthesizing the second electrolyte, a by-product, and a decomposition product. The ratio of the mass of the first solid electrolyte to the mass of the first electrolyte layer 310 may be, for example, 50 mass % or more or 70 mass % or more. The ratio of the mass of the second solid electrolyte to the mass of the second electrolyte layer 320 may be, for example, 50 mass % or more or 70 mass % or more.

The first solid electrolyte included in the first electrolyte layer 310 may be at least one selected from a first group consisting of a plurality of solid electrolytes. The first electrolyte layer 310 may have a single-layer structure or a multi-layer structure. For example, in the case where the first electrolyte layer 310 is composed of a plurality of layers, the layers may be different in composition from each other. The second solid electrolyte included in the second electrolyte layer 320 may be at least one selected from a second group consisting of a plurality of solid electrolytes. The second electrolyte layer 320 may have a single-layer structure or a multi-layer structure. For example, in the case where the second electrolyte layer 320 is composed of a plurality of layers, the layers may be different in composition from each other.

The second solid electrolyte is a material different in composition from the first solid electrolyte. In this case, the first solid electrolyte included in the first group is different in composition from the second solid electrolyte included in the second group. However, a portion of the first electrolyte layer 310 that is not in direct contact with the positive electrode 100 may partially include a solid electrolyte having the same composition as the second electrolyte layer 320 has. In this case, the volume ratio of the solid electrolyte, which is included in the first electrolyte layer 310 and even in the second electrolyte layer 320, to the first electrolyte layer 310 may be, for example, 50% or less, 30% or less, or 10% or less. A portion of the second electrolyte layer 320 that is not in direct contact with the negative electrode 200 may partially include a solid electrolyte having the same composition as the first electrolyte layer 310 has. In this case, the volume ratio of the solid electrolyte, which is included in the second electrolyte layer 320 and even in the first electrolyte layer 310, to the second electrolyte layer 320 may be, for example, 50% or less, 30% or less, or 10% or less.

### <Solid Electrolyte>

The first solid electrolyte and the second solid electrolyte each may include at least one selected from the group consisting of a solid oxide electrolyte, a solid sulfide electrolyte, and a solid halide electrolyte. By selecting the first solid electrolyte according to the operating potential range of the positive electrode 100 and selecting the second solid electrolyte according to the operating potential range of the negative electrode 200, it is possible to prevent chemical transformations of the solid electrolytes and thus an increase in resistance component. Therefore, it is possible to enhance the output characteristics of the battery 1000.

In the present disclosure, the “solid oxide electrolyte” refers to a solid electrolyte including oxygen as major anions. Here, the solid oxide electrolyte may further include, as anions other than oxygen, anions except both sulfur and a halogen element. In the present disclosure, the “solid sulfide electrolyte” refers to a solid electrolyte including sulfur as major anions. In the present disclosure, the “solid halide electrolyte” refers to a solid electrolyte including a halogen element as major anions and being free of sulfur.

At least one selected from the group consisting of the first solid electrolyte and the second solid electrolyte may be a solid oxide electrolyte. According to the above configuration, it is possible to further enhance the output characteristics of the battery 1000.

The solid oxide electrolyte that can be used is, for example, a NASICON solid electrolyte represented by LiTi₂(PO₄)₃ and element-substituted substances thereof, a (LaLi)TiO₃-based perovskite solid electrolyte, a LISICON solid electrolyte represented by Li₁₄ZnGe₄O₁₆, Li₄SiO₄, and LiGeO₄ and element-substituted substances thereof, a garnet solid electrolyte represented by Li₇La₃Zr₂O₁₂ and element-substituted substances thereof, Li₃PO₄ and N-substituted substances thereof, or glass or glass ceramics in which Li₂SO₄, Li₂CO₃, or the like is added to a base material including a Li—B—O compound, such as LiBO₂ or Li₃BO₃. One or two or more solid oxide electrolytes selected from the above materials can be used.

At least one selected from the group consisting of the first solid electrolyte and the second solid electrolyte may be a solid sulfide electrolyte. According to the above configuration, it is possible to further enhance the output characteristics of the battery 1000.

The solid sulfide electrolyte is Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like. Moreover, LiX, Li₂O, MO_{q}, LiₚMO_{q}, or the like may be added to these. Here, the element X is at least one selected from the group consisting of F, Cl, Br, and I. Moreover, the element M is at least one selected from the group consisting of P, Si, Ge, B, Al, Ga, In, Fe, and Zn. The symbols p and q are each a natural number. One or two or more solid sulfide electrolytes selected from the above materials can be used.

At least one selected from the group consisting of the first solid electrolyte and the second solid electrolyte may be a solid halide electrolyte. According to the above configuration, it is possible to further enhance the output characteristics of the battery 1000.

In the present disclosure, the “metalloid elements” refer to B, Si, Ge, As, Sb, and Te. The “metal elements” refer to all the elements included in Groups 1 to 12 of the periodic table except hydrogen, and all the elements included in Groups 13 to 16 of the periodic table except B, Si, Ge, As, Sb, Te, C, N, P, O, S, and Se. That is, the “metalloid elements” and the “metal elements” are each a group of elements that can become cations when forming an inorganic compound with a halogen element.

The solid halide electrolyte can be a material including Li, M, and X. That is, at least one selected from the group consisting of the first solid electrolyte and the second solid electrolyte may include Li, M1, and X. Here, the element M is at least one selected from the group consisting of metalloid elements and metal elements except Li. The element X is at least one selected from the group consisting of F, Cl, Br, and I. According to the above configuration, it is possible to further enhance the ionic conductivity of at least one selected from the group consisting of the first solid electrolyte and the second solid electrolyte. Consequently, it is possible to further enhance the output characteristics of the battery 1000. Moreover, it is possible to enhance the thermal stability of the battery 1000. In the case where the solid electrolyte is free of sulfur, generation of hydrogen sulfide gas can be prevented.

At least one selected from the group consisting of the first solid electrolyte and the second solid electrolyte may be represented by, for example, the following composition formula (1).

Li_{α}M_{β}X_{γ} Formula (1)

Here, α, β, and γ are each a value greater than 0. According to the above configuration, it is possible to enhance the ionic conductivity of at least one selected from the group consisting of the first solid electrolyte and the second solid electrolyte. Consequently, it is possible to enhance the output characteristics of the battery 1000.

In the composition formula (1), 1≤α≤6, 1≤β≤2, and 2≤γ≤8 may be satisfied.

In the composition formula (1), the element M may include Y (=yttrium). That is, at least one selected from the group consisting of the first solid electrolyte and the second solid electrolyte may include Y as a metal element. According to the above configuration, it is possible to further enhance the ionic conductivity of at least one selected from the group consisting of the first solid electrolyte and the second solid electrolyte. Consequently, it is possible to further enhance the charge and discharge characteristics of the battery 1000.

At least one selected from the group consisting of the first solid electrolyte including Y and the second solid electrolyte including Y, may be, for example, a compound represented by the composition formula LiₐMe_{b}Y_{c}X₆. Here, a+mb+3c=6 and c>0 are satisfied. The element Me is at least one selected from the group consisting of the metalloid elements and the metal elements except Li and Y. The symbol m represents the valence of the element Me. The element X is at least one selected from the group consisting of F, Cl, Br, and I.

The element Me may be, for example, at least one selected from the group consisting of Mg, Ca, Sr, Ba, Zn, Sc, Al, Ga, Bi, Zr, Hf, Ti, Sn, Ta, and Nb.

The first solid electrolyte and the second solid electrolyte that can be used are each, for example, the following materials. According to the following configuration, it is possible to further enhance the ionic conductivity of the first solid electrolyte and the ionic conductivity of the second solid electrolyte. Consequently, it is possible to further enhance the output characteristics of the battery 1000.

The first solid electrolyte and the second solid electrolyte each may be a material represented by the following composition formula (A1).

Li_{6-3d}Y_{d}X₆ Formula (A1)

In the composition formula (A1), the element X is at least one selected from the group consisting of Cl, Br, and I. Moreover, 0<d<2 is satisfied.

The first solid electrolyte and the second solid electrolyte each may be a material represented by the following composition formula (A2).

Li₃YX₆ Formula (A2)

In the composition formula (A2), the element X is at least one selected from the group consisting of Cl, Br, and I.

The first solid electrolyte and the second solid electrolyte each may be a material represented by the following composition formula (A3).

Li_{3-3δ}Y_{1+δ}Cl₆ Formula (A3)

In the composition formula (A3), 0<δ≤0.15 is satisfied.

The first solid electrolyte and the second solid electrolyte each may be a material represented by the following composition formula (A4).

Li_{3-3δ}Y_{1+δ}Br₆ Formula (A4)

In the composition formula (A4), 0<δ≤0.25 is satisfied.

The first solid electrolyte and the second solid electrolyte each may be a material represented by the following composition formula (A5).

Li_{3-3δ+a}Y_{1+δ-a}MeₐCl_{6-x-y}BrₓI_{y} Formula (A5)

In the composition formula (A5), the element Me is at least one selected from the group consisting of Mg, Ca, Sr, Ba, and Zn. The relations −1<δ<2, 0<a<3, 0<(3−3δ+a), 0<(1+δ−a), 0≤x≤6, 0≤y≤6, and (x+y)≤6 are satisfied.

The first solid electrolyte and the second solid electrolyte each may be a material represented by the following composition formula (A6).

Li_{3-3δ}Y_{1+δ-a}MeₐCl_{6-x-y}BrₓI_{y} Formula (A6)

In the composition formula (A6), the element Me is at least one selected from the group consisting of Al, Sc, Ga, and Bi. The relations −1<δ<1, 0<a<2, 0<(1+δ−a), 0≤x≤6, 0≤y≤6, and (x+y)≤6 are satisfied.

The first solid electrolyte and the second solid electrolyte each may be a material represented by the following composition formula (A7).

Li_{3-3δ-a}Y_{1+δ-a}MeₐCl_{6-x-y}BrₓI_{y} Formula (A7)

In the composition formula (A7), the element Me is at least one selected from the group consisting of Zr, Hf, and Ti. The relations −1<δ<1, 0<a<1.5, 0<(3−3δ−a), 0<(1+δ−a), 0<x≤6, 0≤y≤6, and (x+y)≤6 are satisfied.

The first solid electrolyte and the second solid electrolyte each may be a material represented by the following composition formula (A8).

Li_{3-3δ-2a}Y_{1+δ-a}MeₐCl_{6-x-y}BrₓI_{y} Formula (A8)

In the composition formula (A8), the element Me is at least one selected from the group consisting of Ta and Nb. The relations −1<δ<1, 0<a<1.2, 0<(3−3δ−2a), 0<(1+δ−a), 0≤x≤6, 0≤y≤6, and (x+y)≤6 are satisfied.

The first solid electrolyte and the second solid electrolyte that can be used are each more specifically, for example, Li₃YX₆, Li₂MgX₄, Li₂FeX₄, Li(Al,Ga,In)X₄, or Li₃(Al,Ga,In)X₆. Here, the element X is at least one selected from the group consisting of Cl, Br, and I.

In the present disclosure, an expression “(A,B,C)” in a chemical formula means “at least one selected from the group consisting of A, B, and C”. For example, “(Al, Ga, In)” is synonymous with “at least one selected from the group consisting of Al, Ga, and In”. The same applies to other elements.

The first solid electrolyte and the second solid electrolyte each may be a compound including Li, M2, X2, and O (oxygen). Here, the element M2 includes, for example, at least one selected from the group consisting of Nb and Ta. Moreover, the element X2 is at least one selected from the group consisting of Cl, Br, and I.

The compound including Li, M2, X2 and O (oxygen) may be, for example, a material represented by the following composition formula (2).

LiₓM2O_{y}X2_{5+x-2y} Formula (2)

Here, x may satisfy 0.1<x<7.0, and y may satisfy 0.4<y<1.9. According to the above configuration, the solid electrolytes have a high ionic conductivity. In the case where a solid electrolyte satisfying the composition formula (2) is used, the battery 1000 can exhibit an excellent charge and discharge efficiency.

At least one selected from the group consisting of the positive electrode 100 and the negative electrode 200 may include an electrolyte material, for example, a solid electrolyte. As the solid electrolyte, which may be included in the electrodes, a solid oxide electrolyte, a solid sulfide electrolyte, a solid halide electrolyte, or a solid complex hydride electrolyte can be used, for example. The solid electrolyte, which may be included in the positive electrode 100, may be, for example, the first solid electrolyte. The solid electrolyte, which may be included in the negative electrode 200, may be, for example, the second solid electrolyte.

The solid oxide electrolyte that may be used is the above solid oxide electrolytes exemplified as the first solid electrolyte and the second solid electrolyte.

The solid sulfide electrolyte that may be used is the above solid sulfide electrolytes exemplified as the first solid electrolyte and the second solid electrolyte.

The solid halide electrolyte that may be used is the compound represented by the above composition formula (1) exemplified as the first solid electrolyte and the second solid electrolyte. The solid halide electrolyte that may be used is the above compound including Li, M2, X2, and O (oxygen). The solid halide electrolyte that may be used is the compound represented by the above composition formula (2).

The solid complex hydride electrolyte that can be used is, for example, LiBH₄—LiI or LiBH₄—P₂S₅.

The shape of the solid electrolytes included in the battery 1000 is not limited. The shape of the solid electrolytes may be, for example, acicular, spherical, or ellipsoidal. The shape of the solid electrolytes may be, for example, particulate.

The positive electrode 100 includes, as the positive electrode active material, a material having properties of occluding and releasing metal ions (e.g., lithium ions), for example. The positive electrode active material that can be used is, for example, a lithium-containing transition metal oxide, a transition metal fluoride, a polyanion material, a fluorinated polyanion material, a transition metal sulfide, a transition metal oxysulfide, or a transition metal oxynitride. The lithium-containing transition metal oxide is, for example, Li(Ni,Co,Al)O₂, Li(Ni,Co,Mn)O₂, or LiCoO₂. In particular, in the case where the lithium-containing transition metal oxide is used as the positive electrode active material, it is possible to reduce the manufacturing cost and increase the average discharge voltage. Moreover, to increase the energy density of the battery, the positive electrode active material may be lithium nickel cobalt manganese oxide. The positive electrode active material may be, for example, Li(Ni,Co,Mn)O₂.

In the case where the shape of the solid electrolyte included in the positive electrode 100 is particulate (e.g., spherical), the median diameter of the solid electrolyte may be 10 nm or more and 10 μm or less. In the case where the median diameter of the solid electrolyte is 10 nm or more and 10 μm or less, the positive electrode active material and the solid electrolyte can form a favorable dispersion state in the positive electrode 100. Consequently, the charge and discharge characteristics of the battery 1000 are enhanced.

The median diameter of the solid electrolyte included in the positive electrode 100 may be smaller than the median diameter of the positive electrode active material. Consequently, the solid electrolyte and the positive electrode active material can form a favorable dispersion state.

The median diameter of the positive electrode active material may be 0.1 μm or more and 100 μm or less. In the case where the median diameter of the positive electrode active material is 0.1 μm or more, the positive electrode active material and the solid electrolyte can form a favorable dispersion state in the positive electrode 100. Consequently, the charge and discharge characteristics of the battery 1000 are enhanced. In the case where the median diameter of the positive electrode active material is 100 μm or less, the diffusion rate of lithium in the positive electrode active material is increased. Consequently, the battery 1000 can operate at a high output.

In the present description, the median diameter of the solid electrolyte and the positive electrode active material means the particle diameter (d50) at a cumulative volume equal to 50% in a volumetric particle size distribution measured by a laser diffraction scattering method. The particle size distribution can also be measured, for example, with an image analyzer. The same applies to other materials.

In the volume ratio “v1:100−v1” of the positive electrode active material and the solid electrolyte included in the positive electrode 100, 30≤v1≤95 may be satisfied, where v1 represents the volume ratio of the positive electrode active material based on 100 of the total volume of the positive electrode active material and the solid electrolyte included in the positive electrode 100. In the case where 30≤v1 is satisfied, a sufficient energy density of the battery can be achieved. In the case where v1≤95 is satisfied, the battery 1000 can operate at a high output.

The average thickness of the positive electrode 100 may be 10 μm or more and 1000 μm or less. In the case where the average thickness of the positive electrode 100 is 10 μm or more, a sufficient energy density of the battery can be achieved. In the case where the average thickness of the positive electrode 100 is 1000 μm or less, the battery 1000 can operate at a high output.

An applicable method for measuring the average thickness of the positive electrode 100 is the method described above for the average thicknesses of the first electrolyte layer 310 and the second electrolyte layer 320 in Embodiment 1 above. The same method is also applicable to the negative electrode 200.

The negative electrode 200 includes, as the negative electrode active material, a material having properties of occluding and releasing metal ions (e.g., lithium ions), for example. The negative electrode active material that can be used is a metal material, a carbon material, an oxide, a nitride, a tin compound, a silicon compound, or the like. The metal material may be a simple substance of metal. The metal material may be an alloy. The metal material is, for example, lithium metal or a lithium alloy. The carbon material is, for example, natural graphite, coke, partially graphitized carbon, a carbon fiber, spherical carbon, artificial graphite, or amorphous carbon. In the case where silicon (Si), tin (Sn), the silicon compound, the tin compound, or the like is used, the capacity density can be enhanced. The oxide is, for example, Li₄Ti₅O₁₂, LiTi₂O₄, or TiO₂.

In the case where the shape of the solid electrolyte included in the negative electrode 200 is particulate (e.g., spherical), the median diameter of the solid electrolyte may be 10 nm or more and 10 μm or less. In the case where the median diameter of the solid electrolyte is 10 nm or more and 10 μm or less, the negative electrode active material and the solid electrolyte can form a favorable dispersion state in the negative electrode 200. Consequently, the charge and discharge characteristics of the battery 1000 are enhanced.

The median diameter of the solid electrolyte included in the negative electrode 200 may be smaller than the median diameter of the negative electrode active material. Consequently, the solid electrolyte and the negative electrode active material can form a favorable dispersion state.

The median diameter of the negative electrode active material may be 0.1 μm or more and 100 μm or less. In the case where the median diameter of the negative electrode active material is 0.1 μm or more, the negative electrode active material and the solid electrolyte can form a favorable dispersion state in the negative electrode 200. Consequently, the charge and discharge characteristics of the battery 1000 are enhanced. In the case where the median diameter of the negative electrode active material is 100 μm or less, the diffusion rate of lithium in the negative electrode active material is increased. Consequently, the battery 1000 can operate at a high output.

In the volume ratio “v2:100−v2” of the negative electrode active material and the solid electrolyte included in the negative electrode 200, 30≤v2≤95 may be satisfied, where v2 represents the volume ratio of the negative electrode active material based on 100 of the total volume of the negative electrode active material and the solid electrolyte included in the negative electrode 200. In the case where 30≤v2 is satisfied, a sufficient energy density of the battery can be achieved. In the case where v2≤95 is satisfied, the battery 1000 can operate at a high output.

The average thickness of the negative electrode 200 may be 10 μm or more and 1000 μm or less. In the case where the average thickness of the negative electrode 200 is 10 μm or more, a sufficient energy density of the battery can be achieved. In the case where the average thickness of the negative electrode 200 is 1000 μm or less, the battery 1000 can operate at a high output.

The positive electrode active material and the negative electrode active material each may be coated with a coating material in order to reduce the interfacial resistance between the active material and the solid electrolyte. The coating material that can be used is a material having a low electronic conductivity. The coating material that can be used is an oxide material, a solid oxide electrolyte, or the like.

The oxide material that can be used is, for example, SiO₂, Al₂O₃, TiO₂, B₂O₃, Nb₂O₅, WO₃, or ZrO₂.

The solid oxide electrolyte that can be used as the coating material is a Li—Nb—O compound such as LiNbO₃, a Li—B—O compound such as LiBO₂ or Li₃BO₃, a Li—Al—O compound such as LiAlO₂, a Li—Si—O compound such as Li₄SiO₄, a Li—Ti—O compound such as Li₂SO₄ or Li₄Ti₅O₁₂, a Li—Zr—O compound such as Li₂ZrO₃, a Li—Mo—O compound such as Li₂MoO₃, a Li-V-O compound such as LiV₂O₅, or a Li—W—O compound such as Li₂WO₄. The solid oxide electrolyte has a high ionic conductivity. The solid oxide electrolyte has an excellent high-potential stability. Accordingly, in the case where the solid oxide electrolyte is used as the coating material, the charge and discharge efficiency of the battery 1000 can be further enhanced.

At least one selected from the group consisting of the positive electrode 100, the first electrolyte layer 310, the second electrolyte layer 320, and the negative electrode 200 may include a binder for the purpose of enhancing the adhesion between the particles. The binder is used to enhance the binding properties of the materials constituting the electrodes. The binder is polyvinylidene fluoride, polytetrafluoroethylene, polyethylene, polypropylene, an aramid resin, a polyamide, a polyimide, a polyamideimide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, carboxymethyl cellulose, or the like. The binder that can be used is also a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, an acrylic acid, and hexadiene. The binder that may be used is a mixture of two or more materials selected from the above materials.

At least one selected from the group consisting of the positive electrode 100 and the negative electrode 200 may include a conductive additive for the purpose of enhancing the electronic conductivity. The conductive additive that can be used is, for example, a graphite such as natural graphite or artificial graphite, a carbon black such as acetylene black or Ketjen black, a conductive fiber such as a carbon fiber or a metal fiber, fluorinated carbon, a metal powder such as an aluminum powder, a conductive whisker such as a zinc oxide whisker or a potassium titanate whisker, a conductive metal oxide such as titanium oxide, or a conductive polymer compound such as a polyaniline compound, a polypyrrole compound, or a polythiophene compound. In the case where a carbon conductive additive is used as the conductive additive, a cost reduction can be sought.

The shape of the battery 1000 is, for example, a coin type, a cylindrical type, a prismatic type, a sheet type, a button type, a flat type, or a laminated type.

A plurality of the batteries 1000, each of which includes the positive electrode 100, the first electrolyte layer 310, the second electrolyte layer 320, and the negative electrode 200, may be laminated with a current collector disposed between the adjacent batteries 1000. Electrically connecting a plurality of batteries in series can increase the voltage of the batteries. Electrically connecting a plurality of batteries in parallel can increase the capacity of the batteries. Electrically connecting a plurality of batteries in series and in parallel can increase the voltage and capacity of the batteries.

### <Method for Manufacturing Battery>

The battery according to the present embodiment can be manufactured, for example, by the following method (dry process).

Solid electrolytes different in composition from each other are prepared as the first solid electrolyte and the second solid electrolyte.

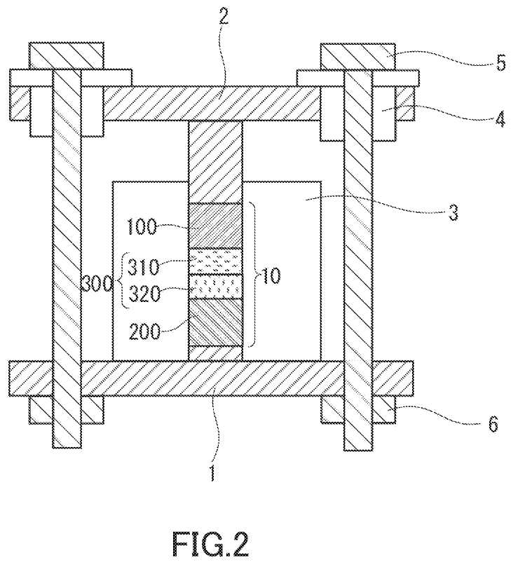

FIG. 2 is a diagram illustrating a method for manufacturing the battery 1000, a battery 2000, and a battery 3000. As shown in FIG. 2, a lower die 1 is inserted into an insulated vessel 3. A powder of the second solid electrolyte is put into the insulated vessel 3. An upper die 2 is inserted into the insulated vessel 3 to apply a pressure to the powder of the second solid electrolyte, and thus to form the second electrolyte layer 320. The upper die 2 is removed, and a powder of the first solid electrolyte is put into the insulated vessel 3. The upper die 2 is inserted again into the insulated vessel 3 to apply a pressure to the powder of the first solid electrolyte, and thus to form the first electrolyte layer 310 on the second electrolyte layer 320. The upper die 2 is removed, and a powder of the positive electrode active material is put into the insulated vessel 3. The upper die 2 is inserted again into the insulated vessel 3 to apply a pressure to the powder of the first solid electrolyte, and thus to form the positive electrode 100 on the first electrolyte layer 310.

At this time, by adjusting the amount of the powder of the first solid electrolyte, the average thickness D1 of the first electrolyte layer 310 can be set larger than the arithmetic average roughness Ra2 of the surface 321 of the second electrolyte layer 320. By adjusting the amount of the powder of the second solid electrolyte, the average thickness D2 of the second electrolyte layer 320 can be set larger than the arithmetic average roughness Ra1 of the surface 311 of the first electrolyte layer 310.

Moreover, even by reducing the particle diameter of the second solid electrolyte, the arithmetic average roughness Ra2 of the surface 321 of the second electrolyte layer 320 can be set smaller than the average thickness D1 of the first electrolyte layer 310. Even by reducing the particle diameter of the first solid electrolyte, the arithmetic average roughness Ra1 of the surface 311 of the first electrolyte layer 310 can be set smaller than the average thickness D2 of the second electrolyte layer 320.

After the positive electrode 100 is formed, the lower die 1 is removed, and a powder of the negative electrode active material and either an indium metal foil punched into a disc shape or a lithium metal foil punched into a disc shape are put into the insulated vessel 3. The lower die 1 is inserted again to apply a pressure to the powder of the negative electrode active material and the indium metal foil or the lithium metal foil, and thus to form the negative electrode 200. Thus, a power generation element 10 is formed.

After the power generation element 10 is formed, the lower die 1 and the upper die 2 are fixed to each other with insulating tubes 4, bolts 5, and nuts 6. Thus, the battery 1000 of Embodiment 1 is obtained.

A battery using the solid electrolyte manufactured above can be manufactured even by a wet process. In this case, coating with a slurry of the second solid electrolyte having a sufficient dispersibility is performed in the coating process so as to smooth the surface of the coating film. Consequently, the arithmetic average roughness Ra2 of the surface 321 of the second electrolyte layer 320 can be set smaller than the average thickness D1 of the first electrolyte layer 310. Moreover, coating with a slurry of the first solid electrolyte having a sufficient dispersibility is performed in the coating process so as to smooth the surface of the coating film. Consequently, the arithmetic average roughness Ra1 of the surface 311 of the first electrolyte layer 310 can be set smaller than the average thickness D2 of the second electrolyte layer 320.

In using a wet process, prior to the lamination of the first electrolyte layer 310 and the second electrolyte layer 320, a pressure may be applied to the electrolyte layers (coating films) by rolling or the like to smooth the surfaces. Even in this case, the arithmetic average roughness Ra2 of the surface 321 of the second electrolyte layer 320 can be set smaller than the average thickness D1 of the first electrolyte layer 310. Moreover, the arithmetic average roughness Ra1 of the surface 311 of the first electrolyte layer 310 can be set smaller than the average thickness D2 of the second electrolyte layer 320.

### Embodiment 2

Embodiment 2 will be described below with reference to FIG. 3. The same constituent elements as those of Embodiment 1 are denoted by the same reference numerals, and the detailed description will be omitted.

FIG. 3 is a sectional view schematically showing the configuration of the battery 2000 according to Embodiment 2. In the battery 2000, the first electrolyte layer 310 includes a first solid electrolyte 312. The first solid electrolyte 312 is a particulate solid electrolyte. An average particle diameter P1 of the first solid electrolyte 312 is smaller than the arithmetic average roughness Ra2 of the surface 321, which is close to the first electrolyte layer 310, of the second electrolyte layer 320. Except for this, the battery 2000 according to Embodiment 2 has the same configuration as the battery 1000 according to Embodiment 1 has.

In the present embodiment, the average particle diameter P1 of the first solid electrolyte 312 is smaller than the arithmetic average roughness Ra2 of the surface 321, which is close to the first electrolyte layer 310, of the second electrolyte layer 320. According to the above configuration, the first solid electrolyte 312 easily enters recessed portions in the surface 321 of the second electrolyte layer 320. This increases the contact area between the first electrolyte layer 310 and the second electrolyte layer 320, and also reduces the voids between the first electrolyte layer 310 and the second electrolyte layer 320. Consequently, the contact strength is enhanced between the first electrolyte layer 310 and the second electrolyte layer 320. This smooths the migration of lithium ions between the first electrolyte layer 310 and the second electrolyte layer 320. Therefore, it is possible to achieve the battery 2000 having enhanced output characteristics.

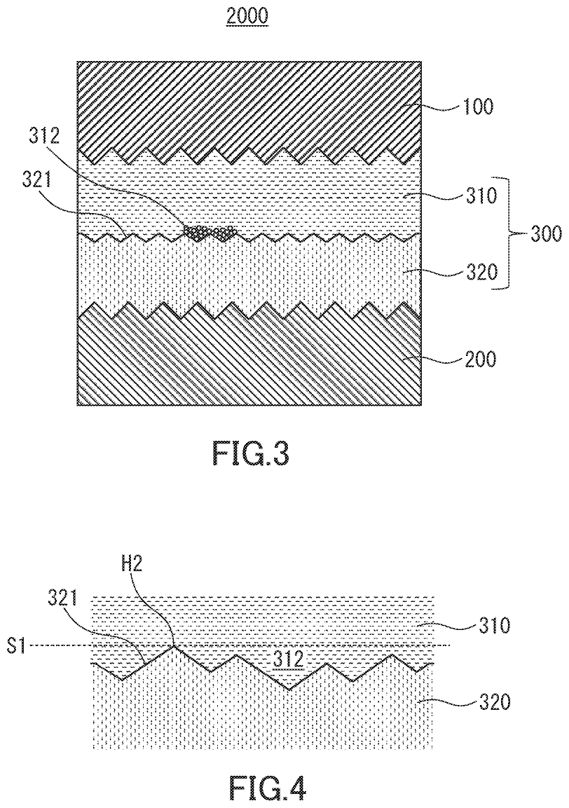

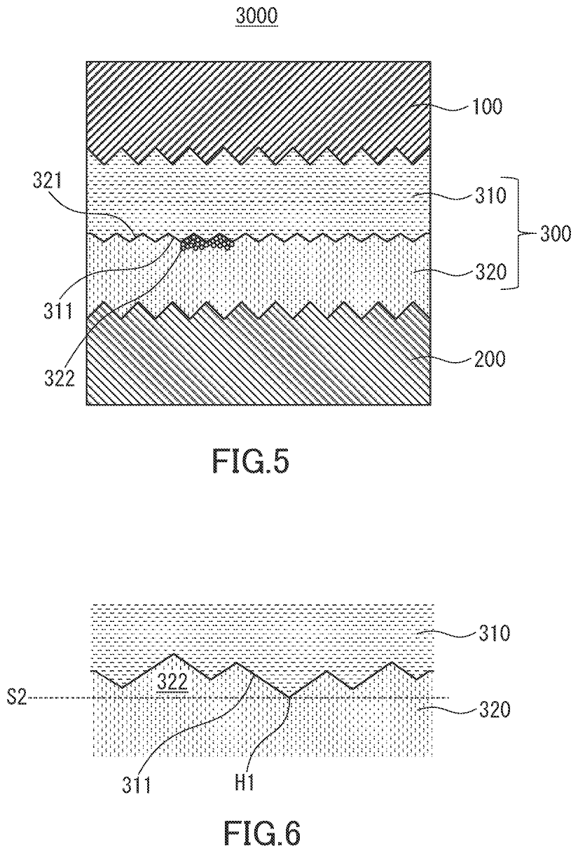

FIG. 4 shows a portion of a section of the battery 2000 parallel to the thickness direction of the battery 2000. FIG. 4 shows an example of a section including the first electrolyte layer 310 and the second electrolyte layer 320 according to Embodiment 2. The average particle diameter P1 of the first solid electrolyte 312 may be the average particle diameter of the first solid electrolyte 312 present at a position in contact with the second electrolyte layer 320. Specifically, on a section as shown in FIG. 4, a reference line that passes through a point H2 defining the maximum height of the surface profile of the second electrolyte layer 320 and that is perpendicular to the thickness direction of the battery 2000 is defined as a first reference line S1. At this time, a first specific particle group of the first solid electrolyte 312 is present between the first reference line S1 and the second electrolyte layer 320, and the average particle diameter P1 of the first solid electrolyte 312 may be the average particle diameter of the first specific particle group. That is, the average particle diameter of the first specific particle group may be smaller than the arithmetic average roughness Ra2 of the surface 321 of the second electrolyte layer 320. Even according to the above configuration, the first electrolyte layer and the second electrolyte layer have reduced voids therebetween. Consequently, it is possible to sufficiently enhance the output characteristics of the battery 2000.

In the present disclosure, the “average particle diameter of a solid electrolyte” means the average value of the particle diameter of the particulate solid electrolyte in the battery 2000 composed of the positive electrode 100, the first electrolyte layer 310, the second electrolyte layer 320, and the negative electrode 200 that are laminated.

The average particle diameter P1 of the first solid electrolyte 312 can be measured by the following method. The section of the first electrolyte layer 310 is observed with a scanning electron microscope. From the sectional SEM image obtained, 20 sample particles of the first solid electrolyte 312 are randomly selected, and the diameter of each of the sample particles is calculated by image processing. The “diameter” of each of the sample particles is defined as follows. The sample particle with an indeterminate shape is converted into a circle having the same area as the projected area of the sample particle on a two-dimensional plane, and the diameter of the sample particle is defined as the diameter of the circle (equivalent circle diameter). Subsequently, from among the 20 sample particles, 10 sample particles having larger diameters are selected. The average value of the diameters of the 10 sample particles is calculated, and thus the average particle diameter can be obtained. Instead of the scanning electron microscope, an optical microscope can also be used, for example.

The average particle diameter P1 of the first solid electrolyte 312 can be the average particle diameter of the first solid electrolyte 312 present at the position in contact with the second electrolyte layer 320. Specifically, the average particle diameter P1 of the first solid electrolyte 312 can be the average particle diameter of the first solid electrolyte 312 filling the recessed portions in the surface 321. In this case, the average particle diameter P1 of the first solid electrolyte 312 can be measured from 10 randomly selected sample particles of the first solid electrolyte 312 filling the recessed portions in the surface 321 of the second electrolyte layer 320 in the sectional SEM image obtained.

The average particle diameter P1 of the first solid electrolyte 312 may be 10 nm or more and 10 μm or less. In the case where the average particle diameter P1 of the first solid electrolyte 312 is 10 nm or more, the first solid electrolyte 312 has a sufficient ionic conductivity. In the case where the average particle diameter P1 of the first solid electrolyte 312 is 10 μm or less, the first electrolyte layer 310 and the second electrolyte layer 320 have sufficiently reduced voids therebetween.

The average particle diameter P1 of the first solid electrolyte 312 may be 0.1 μm or more and 1 μm or less. In the case where the average particle diameter P1 of the first solid electrolyte 312 is 0.1 μm or more, the first solid electrolyte 312 has a sufficient ionic conductivity. In the case where the average particle diameter P1 of the first solid electrolyte 312 is 1 μm or less, the first electrolyte layer 310 and the second electrolyte layer 320 have sufficiently reduced voids therebetween.

The arithmetic average roughness Ra2 of the surface 321, which is close to the first electrolyte layer 310, of the second electrolyte layer 320 may be two times or more or five times or more the average particle diameter P1 of the first solid electrolyte 312. The upper limit for the ratio Ra2/P1 of the arithmetic average roughness Ra2 to the average particle diameter P1 is not particularly limited. The ratio Ra2/P1 may be 100 or less or 1000 or less.

### <Method for Manufacturing Battery>

The battery 2000 of Embodiment 2 can be obtained by the method described for the battery 1000 of Embodiment 1.

The synthesis conditions for the first solid electrolyte 312 are set so that the average particle diameter P1 of the first solid electrolyte 312 falls below the arithmetic average roughness Ra2 of the surface 321 of the second electrolyte layer 320.

### Embodiment 3

Embodiment 3 will be described below with reference to FIG. 4. The same constituent elements as those of Embodiment 1 are denoted by the same reference numerals, and the detailed description will be omitted.

FIG. 4 is a sectional view schematically showing the configuration of the battery 3000 according to Embodiment 3. In the battery 3000, the second electrolyte layer 320 includes a second solid electrolyte 322. The second solid electrolyte 322 is a particulate solid electrolyte. An average particle diameter P2 of the second solid electrolyte 322 is smaller than the arithmetic average roughness Ra1 of the surface 311, which is close to the second electrolyte layer 320, of the first electrolyte layer 310. Except for this, the battery 3000 according to Embodiment 3 has the same configuration as the battery 1000 according to Embodiment 1 has.

In the present embodiment, the average particle diameter P2 of the second solid electrolyte 322 is smaller than the arithmetic average roughness Ra1 of the surface 311, which is close to the second electrolyte layer 320, of the first electrolyte layer 310. According to the above configuration, the second solid electrolyte 322 easily enters recessed portions in the surface 311 of the first electrolyte layer 310. This increases the contact area between the first electrolyte layer 310 and the second electrolyte layer 320, and also reduces the voids between the first electrolyte layer 310 and the second electrolyte layer 320. Consequently, the contact strength is enhanced between the first electrolyte layer 310 and the second electrolyte layer 320. This smooths the migration of lithium ions between the first electrolyte layer 310 and the second electrolyte layer 320. Therefore, it is possible to achieve the battery 3000 having enhanced output characteristics.

FIG. 6 shows a portion of a section of the battery 3000 parallel to the thickness direction of the battery 3000. FIG. 6 shows an example of a section including the first electrolyte layer 310 and the second electrolyte layer 320 according to Embodiment 3. The average particle diameter P2 of the second solid electrolyte 322 may be the average particle diameter of the second solid electrolyte 322 present at a position in contact with the first electrolyte layer 310. Specifically, on a section as shown in FIG. 6, a reference line that passes through a point H1 defining the maximum depth of the surface profile of the first electrolyte layer 310 and that is perpendicular to the thickness direction of the battery 3000 is defined as a second reference line S2. At this time, a second specific particle group of the second solid electrolyte 322 is present between the second reference line S2 and the first electrolyte layer 310, and the average particle diameter P2 of the second solid electrolyte 322 may be the average particle diameter of the second specific particle group. That is, the average particle diameter of the second specific particle group may be smaller than the arithmetic average roughness Ra1 of the surface 311 of the first electrolyte layer 310. Even according to the above configuration, the first electrolyte layer and the second electrolyte layer have reduced voids therebetween. Consequently, it is possible to sufficiently enhance the output characteristics of the battery 3000.

The average particle diameter P2 of the second solid electrolyte 322 may be two times or more or five times or more the arithmetic average roughness Ra1 of the surface 311, which is close to the second electrolyte layer 320, of the first electrolyte layer 310.

In the present embodiment, the first solid electrolyte 312 is a particulate solid electrolyte, and the average particle diameter P1 of the first solid electrolyte 312 may be smaller than the arithmetic average roughness Ra2 of the surface 321, which is close to the first electrolyte layer 310, of the second electrolyte layer 320. According to the above configuration, it is possible to further enhance the output characteristics of the battery 3000.

In the present embodiment, the average particle diameter P1 of the first solid electrolyte 312 may be the average particle diameter of the first solid electrolyte 312 present at the position in contact with the second electrolyte layer 320. Specifically, the average particle diameter P1 of the first solid electrolyte 312 filling the recessed portions in the surface 321 of the second electrolyte layer 320 may be smaller than the arithmetic average roughness Ra2 of the surface 321 of the second electrolyte layer 320.

An applicable method for measuring the average particle diameter P2 of the second solid electrolyte 322 is the method described for the average particle diameter P1 of the first solid electrolyte 312 in Embodiment 2 above.

The average particle diameter P2 of the second solid electrolyte 322 can be the average particle diameter of the second solid electrolyte 322 present at the position in contact with the first electrolyte layer 310. Specifically, the average particle diameter P2 of the second solid electrolyte 322 can be the average particle diameter of the second solid electrolyte 322 filling the recessed portions in the surface 311. In this case, the average particle diameter P2 of the second solid electrolyte 322 can be measured from 10 randomly selected sample particles of the second solid electrolyte 322 filling the recessed portions in the surface 311 of the first electrolyte layer 310 in the sectional SEM image obtained.

The average particle diameter P2 of the second solid electrolyte 322 may be 10 nm or more and 10 μm or less. In the case where the average particle diameter P2 of the second solid electrolyte 322 is 10 nm or more, the second solid electrolyte 322 has a sufficient ionic conductivity. In the case where the average particle diameter P2 of the second solid electrolyte 322 is 10 μm or less, the first electrolyte layer 310 and the second electrolyte layer 320 have sufficiently reduced voids therebetween. The average particle diameter P1 of the first solid electrolyte 312 and the average particle diameter P2 of the second solid electrolyte 322 may be equal to or different from each other.

The average particle diameter P2 of the second solid electrolyte 322 may be 0.1 μm or more and 1 μm or less. In the case where the average particle diameter P2 of the second solid electrolyte 322 is 0.1 μm or more, the first solid electrolyte 312 has a sufficient ionic conductivity. In the case where the average particle diameter P2 of the second solid electrolyte 322 is 1 μm or less, the first electrolyte layer 310 and the second electrolyte layer 320 have sufficiently reduced voids therebetween.

The arithmetic average roughness Ra1 of the surface 311, which is close to the second electrolyte layer 320, of the first electrolyte layer 310 may be two times or more or five times or more the average particle diameter P2 of the second solid electrolyte 322. The upper limit for the ratio Ra1/P2 of the arithmetic average roughness Ra1 to the average particle diameter P2 is not particularly limited. The ratio Ra1/P2 may be 100 or less or 1000 or less.

### <Method for Manufacturing Battery>

The battery 3000 of Embodiment 3 can be obtained by the method described for the battery 1000 of Embodiment 1.

The synthesis conditions for the second solid electrolyte 322 are set so that the average particle diameter P2 of the second solid electrolyte 322 falls below the arithmetic average roughness Ra1 of the surface 311 of the first electrolyte layer 310.

### INDUSTRIAL APPLICABILITY

The battery of the present disclosure can be used as, for example, an all-solid-state lithium-ion secondary battery.

What is claimed is:

1. A battery comprising a positive electrode, a first electrolyte layer, a second electrolyte layer, and a negative electrode in this order, wherein
the first electrolyte layer comprises a first solid electrolyte,
the second electrolyte layer comprises a second solid electrolyte,
the first solid electrolyte is different in composition from the second solid electrolyte,
an average thickness of the first electrolyte layer is larger than an arithmetic average roughness of a surface of the second electrolyte layer, the surface being close to the first electrolyte layer, and
an average thickness of the second electrolyte layer is larger than an arithmetic average roughness of a surface of the first electrolyte layer, the surface being close to the second electrolyte layer.

2. The battery according to claim 1, wherein
the average thickness of the first electrolyte layer is 500 μm or less, and
the average thickness of the second electrolyte layer is 500 μm or less.

3. The battery according to claim 1, wherein
the first solid electrolyte is a particulate solid electrolyte, and
an average particle diameter of the first solid electrolyte is smaller than the arithmetic average roughness of the surface of the second electrolyte layer, the surface being close to the first electrolyte layer.

4. The battery according to claim 3, wherein
on a section of the battery parallel to a thickness direction of the battery, when a reference line that passes through a point defining a maximum height of a surface profile of the second electrolyte layer and that is perpendicular to the thickness direction is defined as a first reference line,
a first specific particle group of the first solid electrolyte is present between the first reference line and the second electrolyte layer on the section, and
the average particle diameter of the first solid electrolyte is an average particle diameter of the first specific particle group.

5. The battery according to claim 1, wherein
the second solid electrolyte is a particulate solid electrolyte, and
an average particle diameter of the second solid electrolyte is smaller than the arithmetic average roughness of the surface of the first electrolyte layer, the surface being close to the second electrolyte layer.

6. The battery according to claim 5, wherein
on a section of the battery parallel to a thickness direction of the battery, when a reference line that passes through a point defining a maximum depth of a surface profile of the first electrolyte layer and that is perpendicular to the thickness direction is defined as a second reference line,
a second specific particle group of the second solid electrolyte is present between the second reference line and the first electrolyte layer on the section, and
the average particle diameter of the second solid electrolyte is an average particle diameter of the second specific particle group.

7. The battery according to claim 1, wherein
at least one selected from the group consisting of the first solid electrolyte and the second solid electrolyte is a solid oxide electrolyte.

8. The battery according to claim 1, wherein
at least one selected from the group consisting of the first solid electrolyte and the second solid electrolyte is a solid sulfide electrolyte.

9. The battery according to claim 1, wherein
at least one selected from the group consisting of the first solid electrolyte and the second solid electrolyte comprises Li, M, and X,
the M is at least one selected from the group consisting of metalloid elements and metal elements except Li, and
the X is at least one selected from the group consisting of F, Cl, Br, and I.

10. The battery according to claim 9, wherein
the at least one selected from the group consisting of the first solid electrolyte and the second solid electrolyte is represented by the following composition formula (1)
Li_{α}M_{β}X_{γ} Formula (1)
where α, β, and γ are each a value greater than 0.
